(19) United States
(12) Patent Application Publication
(10) Pub. No.: US 2024/0015505 A1
(43) Pub. Date: Jan. 11, 2024

(54) Enterprise Policies and Geofencing Information Provisioning

(71) Applicant: Celona, Inc., Campbell, CA (US)

(72) Inventors: Srinivasan Balasubramanian, San Diego, CA (US); Puneet Prabhakar Sheety, San Francisco, CA (US); Rajeshwar Poona, San Jose, CA (US)

(21) Appl. No.: 18/349,158

(22) Filed: Jul. 9, 2023

Related U.S. Application Data
(60) Provisional application No. 63/388,146, filed on Jul. 11, 2022.

(51) Int. Cl. H04W 12/06; H04W 12/40; H04W 12/64

(52) U.S. Cl. CPC H04W 12/06; H04W 12/40; H04W 12/64

(57) ABSTRACT

A system in which a plurality of UEs (User Equipment), each of which have access to one or more enterprise networks can be provided with credentials to access those enterprise network to which they have been granted access and in which system each such UE is provided with geofencing information for those enterprise networks to which a UE has been granted access (i.e., has been assigned credentials). The UE uses the geofencing information to determine whether to look for enterprise network transceivers (e.g., access points, eNBs or gNBs) though which the UE can gain wireless access to the enterprise network.

### CLAIM OF PRIORITY TO PREVIOUSLY FILED PROVISIONAL APPLICATION—INCORPORATION BY REFERENCE

This non-provisional application claims priority to an earlier-filed provisional application No. 63/388,146 filed Jul. 11, 2022, entitled “Enterprise Policies and Geofencing Information Provisioning” (ATTY DOCKET NO. CEL-090-PROV) and the provisional application No. 63/388,146 filed Jul. 11, 2022, and all its contents, are hereby incorporated by reference herein as if set forth in full.

### BACKGROUND

### (1) Technical Field

The disclosed method and apparatus relate generally to wireless enterprise networks. In particular, the disclosed method and apparatus relates to provisioning geofencing information associated with a given enterprise network.

### (2) Background

When a UE (user equipment) device (hereafter referred to simply as a “UE”) is a member of an enterprise network, that UE can access resources and capabilities through the enterprise network. These resources and capabilities may include the ability to communicate with other members of the enterprise network (e.g., other UEs), access to applications that allow the UE to access databases (either within the enterprise network or external to the enterprise network) and take advantage of many other capabilities and resources available to members of the enterprise network.

In order to take advantage of the benefits of being a member of the enterprise network, the UE must first “camp onto” the enterprise network. To camp onto the enterprise network, the UE must determine that it is in within the “footprint” of the enterprise network. That is, the UE must determine that it is within range of an enterprise network transceiver with which the UE can wirelessly communicate. One way to make that determination is for the UE to attain information from which the UE can determine the physical boundaries of the enterprise network (i.e., the geographic locations where a UE should be able to make wireless contact with a transceiver operating in the enterprise network). Identifying the physical boundaries of an enterprise network and making that information available to UEs that are members of the enterprise network is commonly referred to as “provisioning of geofencing information”. Provisioning of geofencing information for a given enterprise requires a custom enterprise identifier to be assigned to the enterprise network. That identifier must then be associated with the SIM (Subscriber Identity Module) credential of member UEs to allow those member UEs to access geofencing information that indicates whether the UE is within or outside the physical boundaries of the enterprise network.

The UE uses this identifier to reach a server in which geofencing information associated with different enterprises is stored. The appropriate geofence information for those enterprise networks with which the UE is a member can then be “pushed” to the UE. Therefore, the SIM profile of those member UEs need to be established in a manner that provides the enterprise identifier as a part of the SIM profile. Furthermore, each enterprise network needs to be customized before the credentials that are used to authorize the UE to access the geofencing information can be pushed from the enterprise network to the UE.

It would be desirable to allow credentials to be associated with enterprise networks, potentially on a global basis, in order to make it easy to distribution the credentials to individual UEs that are members of such enterprise networks.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates the components of a system in which a plurality of UEs (User Equipment) can be provided with credentials to access an enterprise network and to provide each such UE with geofencing information.

FIG. 2 illustrates the message flow between components within the system.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

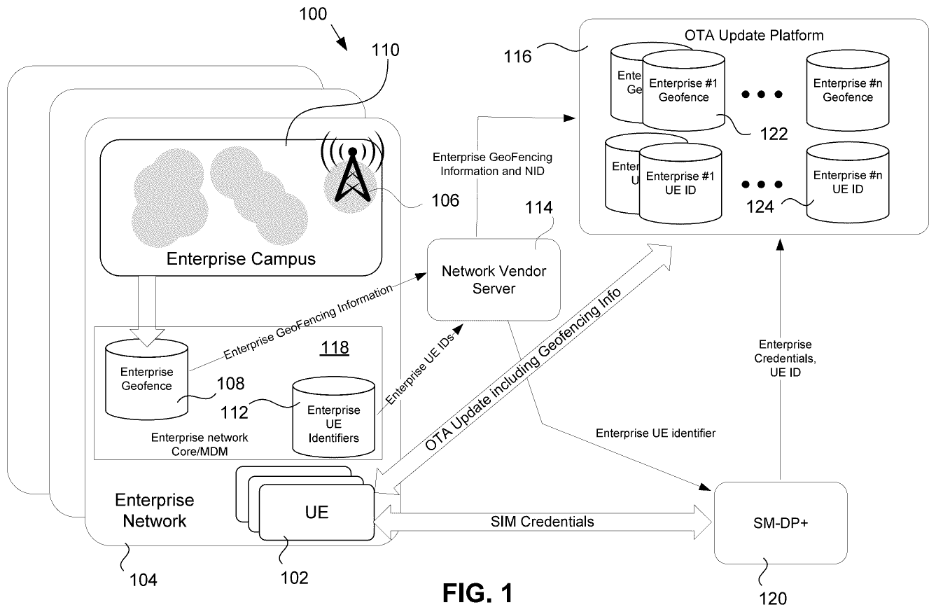

FIG. 1 illustrates the components of a system 100 in which a plurality of UEs (User Equipment) 102, each of which have access to one or more enterprise networks 104 can be provided with credentials to access those enterprise network 104 to which they have been granted access and to provide each such UE with geofencing information for those enterprise networks 104 to which a UE 102 has been granted access (i.e., has been assigned credentials). The UE 102 uses the geofencing information to determine whether to look for enterprise network transceivers 106 (e.g., access points, eNBs or gNBs) though which the UE 102 can gain wireless access to the enterprise network 104.

In some embodiments, an enterprise network geofencing storage device 108 within the enterprise network 104 allows geofencing information to be stored locally in the enterprise network 104. It should be noted that this storage device 108 need not be physically located on the enterprise network campus 110. In some embodiments, an enterprise UE identifier storage device 112 is also provided. As the name implies, the enterprise UE identifier storage device 112 stores the identifier information associated with UEs 102 that are members of the enterprise network 104 (i.e., UEs that have credentials that allow the UE 102 to access resources through the enterprise network 104).

In some embodiments, a SIM provisioning vendor sources credentials that area used to authenticate UEs 102 to allow the UEs 102 access to various networks. A SIM Provisioning Vendor initially provisions (i.e., provides credentials to) UEs 102 that are designated by an enterprise network 104 as being members of the enterprise network 104. In some embodiments, an SM-DP+ (Subscriber Management-Data Preparation with integrated Secure Router) 120 is provided by the SIM Provisioning Vendor to perform the initial provisioning.

In some embodiments, a network vendor is responsible for the initial deployment of the enterprise network 104, including deploying the transceivers 106, network core (not shown) and other components of the enterprise network 104 that are required to establish the network 104. A network vendor server 114 provides credentials to the Enterprise network core/MDM 118. The network vendor server 114 also provides an interface between the enterprise network geofencing storage device 108 and an OTA (over the air) Update Platform 116.

The OTA Update Platform 116 is used to update information within the SIM profile maintained in a UE 102. In addition, the OTA Update Platform 116 maintains storage for enterprise geofencing information 122 and UE identification information 124. In some embodiments, the information for each enterprise network 104 is securely stored in an independently secured storage 122, 124. In the system shown in FIG. 1, information for n different enterprise networks are stored in the OTA Update Platform 116.

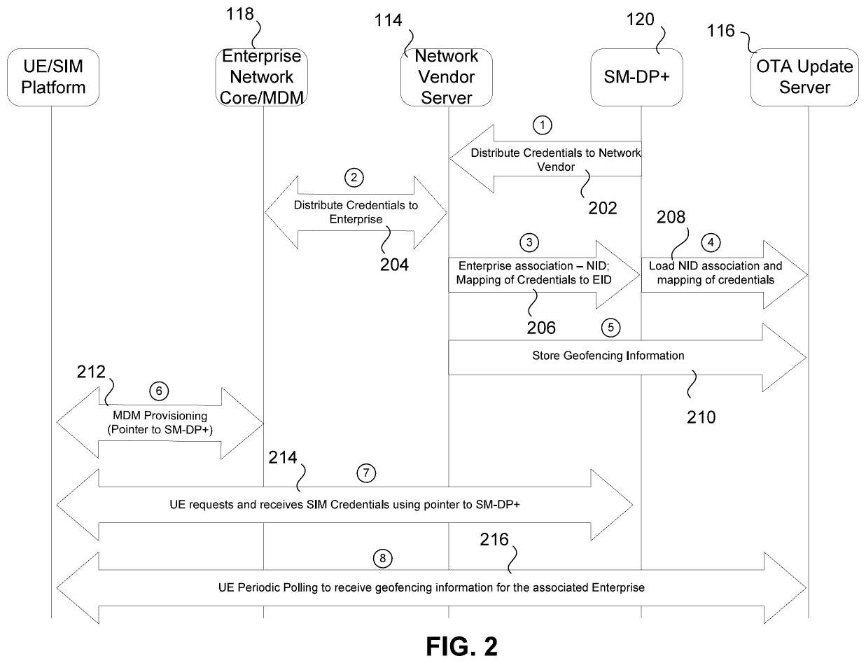

FIG. 2 illustrates the message flow between components within the system 100. Initially, authentication credentials are sourced by the SIM Provisioning Vendor. Accordingly, the SIM Provisioning Vendor operates the SM-DP+ 120, which distributes the credentials to a network vendor server 114. The network vendor server 114 may support the deployment and management of several enterprise networks 104 owned and operated by one or more different enterprise entities. For example, the SIM Provisioning Vendor might have millions of individual credentials that it typically releases in batches for distribution. One particular, a Network Vendor may purchase a batch of 10,000 of those credentials for use by the networks that the Network Vendor is deploying for various enterprises. As part of this process, the credentials are distributed by the SM-DP+ 120 to the Network Vendor Server 114 in an exchange 202. One particular network may receive 100 of those credentials. In this example, those 100 credentials are then sent from the Network Vendor Server 114 to the Enterprise Network Core/MDM 118 in an exchange 204. Communications may occur in both directions to complete the exchange 204. The network 104 would then assign one or more of those credentials to UEs 102 to which the network will authorize access to network 104. The credentials are associated with a UE identifier (e.g., an EID (Embedded Identifier)) and the mapping of the credential and the UE identifier are then stored within the enterprise UE identifier storage device 112. As part of this exchange 204, the enterprise network provides the UE identifiers to the Network Vendor Server 114 to inform the network vendor which UEs 102 have been authorized to access the enterprise network 104. The network vendor then sends the enterprise association information (i.e., the identity of the UEs 102 that are associated with the enterprise network) together with a NID (network Identifier) to the SM-DP+ 120 in an exchange 206.

In some embodiments, the SM-DP+ 120 sends the EID for each UE 202 and the associated NID to the OTA Update Server 116 in an exchange 208. In some embodiments, the geofencing information is provided to the OTA Update Server 116 in an exchange 210 from the Network Vendor Server 114. Accordingly, a request from a UE 102 may request geofencing information by including the EID of the UE 102 in the request to the OTA Update Server 116 (see exchange 216). In some embodiments, rather than having the NID and associated EIDs sent to the OTA Update Server 116 from the SM-DP+ 120, this association of NID to EIDs can be provided by the Network Vendor Server 114 together with the geofencing information. In either case, the geofencing information is stored in the OTA Update Server in association with the NID. However, by having the Network Vendor Server 114 provide the NIDs to the SM-DP+ 120, the SM-DP+ 120 can place the NIDs into the package of information that will be downloaded to the UE 102 during provisioning of the UE 102 with the credentials associated with the EID by the SM-DP+ 120. It should be noted that this saves the network vendor from having to associate each UE 102 with the NID.

It should be noted that in some embodiments, the NID need not be provided, since the EIDs are associated with the particular enterprise network through the mapping of the EIDs to the NIDs that is provide in either the exchange 208 or the exchange 210.

Once the SM-DP+ 120 has been updated with information regarding the credentials assigned and associated with the EIDs, pointers can be communicated by the enterprise network core/MDM 118 to the UEs 102 in an exchange 212. UEs 102 can then request provisioning from the SM-DP+ 120 in order to receive the required enterprise network authorization credentials to be associated with the EID of the particular requesting UE 102 in an exchange 214. The UEs 102 can also request an initial download of the geofencing information and subsequent updates to the geofencing information in exchanges 216. Updates can be requested on regular intervals or upon the occurrence of particular trigger events. In addition, or alternatively, updates can be requested in response to a UE 102 receiving instructions to update the geofencing information.

One advantage of the disclosed method and apparatus is that generic profiles (i.e., ICCIDs) can be provided to network devices (network UEs) without any added enterprise specific information. That is, since the SM-DP+ adds the NID after the enterprise has assigned the credentials (e.g., the ICCID) to a particular EIDs, such information does not need to be provided prior to the SM-DP+ provisioning the UE.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
a) Receiving in an enterprise network core/MDM a batch of authentication credentials;
b) The enterprise network core/MDM assigning the received credentials to EIDs, wherein each EID is associated with an authentication credential that is not yet associated with an NID;
c) Providing to a UE, information from which the UE can access an assigned authentication credential with an associated NID from a SIM Provisioning Vendor based on the EID associated with the UE; and
d) Accessing geofencing information from a geofencing server based on the EID of the UE.
